(19) United States
(12) Patent Application Publication
(10) Pub. No.: US 2005/0274019 A1
(43) Pub. Date: Dec. 15, 2005

(54) Shaving head for a dry shaver

(75) Inventors: Tomoyuki Inoue, Hikone-shi (JP); Ryuji Otani, Osaka-shi (JP); Takeshi Shiba, Hikone-shi (JP); Makoto Fukutani, Hikone-shi (JP); Masaaki Sato, Hikone-shi (JP); Shunsuke Komori, Omihachiman-shi (JP)

Correspondence Address: RADER FISHMAN & GRAUER PLLC, LION BUILDING, 1233 20TH STREET N.W., SUITE 501, WASHINGTON, DC, 20036, US

(73) Assignee: MATSUSHITA ELECTRIC WORKS, LTD

(21) Appl. No.: 11/151,280

(22) Filed: Jun. 14, 2005

(30) Foreign Application Priority Data
Jun. 14, 2004 (JP) 2004-176154

(51) Int. Cl. B26B 19/12

(52) U.S. Cl. 30/43.7

(57) ABSTRACT

A shaving head for a dry shaver is capable of increasing the cutting efficiency, yet allowing the use of the inner cutter of simple structure. The shaving head has a slit cutter unit composed of an outer cutter shaped to have a top surface for contact with a user's skin, and an inner cutter in contact with a bottom surface of the outer cutter. The outer cutter has a U-shaped structure with a pair of legs connected by a crossbar, and to have a plurality of slits which are spaced in a lengthwise axis of the outer cutter to leave a plurality of bridges each between the adjacent ones of the slits. The slits extend continuously over a full width of the crossbar and into upper ends of the legs in a direction generally perpendicular to the lengthwise axis, giving two straight slit paths respectively on opposite width ends of the outer cutter. The straight slit paths on the opposite width ends are staggered with respect to each other along the lengthwise axis. Each of the bridges extends along the width axis of the outer cutter to make the bottom surface of the outer cutter smoothly continuous over the full length of the bridge, and that each bridge is formed at its longitudinal center with a deflection which is angled with respect to the width axis so as to leave, between the adjacent ones of the deflections, an angled path through which the straight slit paths of each slit extends continuously.

### FIELD OF THE INVENTION

The present invention is directed to a shaving head for a dry shaver, and more particularly to a shaving head including a slit cutter unit.

### BACKGROUND OF THE INVENTION

In order to entrap and cut relatively long hairs, there have been proposed so-called slit cutter unit composed of a straight outer cutter with a plurality of hair introducing slits and an inner cutter with a plurality of blades reciprocating relative to the outer cutter along a lengthwise axis of the outer cutter. Japanese Patent Publication No. 10-323463 discloses a shaving head having the slit cutter unit, in which the outer cutter is configured to provide two arrays of slits respectively on opposite width ends of the outer cutter. The arrays of slits are staggered with each other along the lengthwise axis in order to cover substantially the full length of the outer cutter, aiming to entrap the hairs over a wide skin area by moving the shaving head back and forth in a direction perpendicular to the lengthwise axis. For this purpose, the outer cutter is configured to have a parallel pair of raised platforms which are spaced in a width direction of the outer cutter for contact with the skin, and are provided respectively with the arrays of the slits. The raised platforms are connected by a trough within which a comb is disposed for smoothing the hairs. Due to the intervention of the trough, top surfaces of the raised platforms on opposite widthwise sides of the outer cutter are interrupted, i.e., bridges defined between the adjacent ones of the slits on the one raised platforms become discontinuous from the corresponding bridges on the other raised platform. Thus, it is likely that the hair entrapped between the slit in the one raised platform is not successfully guided to the staggered slit in the other platform, while the outer cutter is moved across the skin. This means that the hair may have a chance of being cut only within the slit in one of the platforms, reducing the hair cutting efficiency. Moreover, since the bottom surfaces of the platforms are discontinuous, the inner cutter has to be shaped in a rather complex configuration, which eventually leads to the increase in fabrication cost and even reduces the effective shearing contact area between the outer cutter and the inner cutter to lower the cutting efficiency.

### DISCLOSURE OF THE INVENTION

In view of the above problems, the present invention has been achieved to provide an improved shaving head for a dry shaver which is capable of increasing the cutting efficiency, yet allowing the use of the inner cutter of simple structure. The shaving head in accordance with the present invention has a slit cutter unit which comprises an outer cutter shaped to have a top surface for contact with a user's skin, and an inner cutter driven to reciprocate in engagement with a bottom surface of the outer cutter. The outer cutter is elongated to have a lengthwise axis and a width axis. The outer cutter is configured to have a U-shaped structure with a pair of legs connected by a crossbar, and to have a plurality of slits which are spaced in the lengthwise axis to leave a plurality of bridges each between the adjacent ones of the slits. The slits extend continuously over a full width of the crossbar and into upper ends of the legs in a direction generally perpendicular to the lengthwise axis, giving two straight slit paths respectively on opposite width ends of the outer cutter. The straight slit paths on the opposite width ends are staggered with respect to each other along the lengthwise axis. The feature of the present invention resides in that each of the bridges extends along the width axis of the outer cutter to make the bottom surface of the outer cutter smoothly continuous over the full length of the bridge, and that each bridge is formed at its longitudinal center with a deflection which is angled with respect to the width axis so as to leave, between the adjacent ones of the deflections, an angled path through which the straight slit paths of each slit extends continuously. With this feature, it is possible to smoothly guide the hair once entrapped in one of the straight slit paths into the other straight slit path, increasing a chance of cutting the hair. Moreover, the smooth bottom surface of the outer cutter allows the use of the inner cutter of a simple structure, as well as enlarges the effective shearing contact area between the outer cutter and the inner cutter, thereby increasing the cutting efficiency.

It is preferred that the outer cutter is preferred to be shaped from a single metal sheet. Also, it is preferred that each bridge is shaped to have, along the lengthwise axis, a trapezoidal cross-section with a longer base side defined by the bottom surface and with a shorter top side defined by the top surface of the outer cutter, in order to successfully introduce the hairs into the straight slit paths.

Further, each bridge may be formed in its top surface with a notch which acts to raise the flattened hairs while the outer cutter is moving in contact with the skin, improving the cutting efficiency in combination of the staggered slit arrangement. The notch is preferably formed in the top surface of the deflection.

The outer cutter is preferred to have its top surface curved along the lengthwise axis to have its lengthwise center projecting than the opposite lengthwise ends in order to fit the outer cutter intimately successfully on a curved skin portion for cutting the hairs at such portion.

Each bridge may be tapered towards its longitudinal ends to have a thickness which is smaller at the longitudinal ends thereof to have a width which is smaller at the longitudinal ends than at the deflection, thereby introducing the hairs into the slits successfully.

The shaving head of the present invention may include a perforated cutter unit comprising an outer cutter foil having a plurality of perforations for introducing the hairs, and an inner cutter driven to move relative to the outer cutter foil.

In a dry shaver including the above-mentioned shaving head and a motor having a driving element which is connected to drive the inner cutters, it is preferred that the inner cutter of the slit cutter unit is made of a metal into a unitary structure having a hook fro engagement with a coupler made of a plastic material for connection with the driving element. The coupler is formed with studs which are mechanically engaged and heat-welded to the hook for establishing secure connection between the inner cutter and the coupler made of different materials.

These and still other advantageous features of the present invention will become more apparent from the following detailed explanation of the preferred embodiments when taken in conjunction with the attached drawings.

### BRIEF DESCRIPTION OF THE DRAWINGS

FIG. 1 is a perspective view of a dry shaver with a shaving head in accordance with a preferred embodiment of the present invention;

FIG. 2 is an exploded perspective view of the shaving head with associated parts of the shaver;

FIG. 3 is a cross-section of the shaving head with associated parts of the shaver;

FIG. 4 is an exploded perspective view of the shaving head;

FIG. 5 is an exploded perspective view of a portion of the shaving head;

FIG. 6 is a perspective view of a slit cutter unit included in the shaving head;

FIGS. 7 to 9 are respectively top, front, and bottom views of the slit cutter unit;

FIG. 10 is an exploded perspective view of the slit cutter unit;

FIG. 11 is a perspective view of an outer cutter of the slit cutter unit;

FIG. 12 is a top view of the outer cutter of the slit cutter unit;

FIG. 13 is a cross-section taken along line X-X of FIG. 12;

FIG. 14 is a cross-section taken along line Y-Y of FIG. 12;

FIG. 15 is a sectional view of the slit cutter unit;

FIG. 16 a perspective view illustrating a modification of the outer cutter of the slit cutter unit; and

FIG. 17 is a sectional view of the slit cutter unit of the above modification.

### BEST MODE FOR CARRYING OUT THE INVENTION

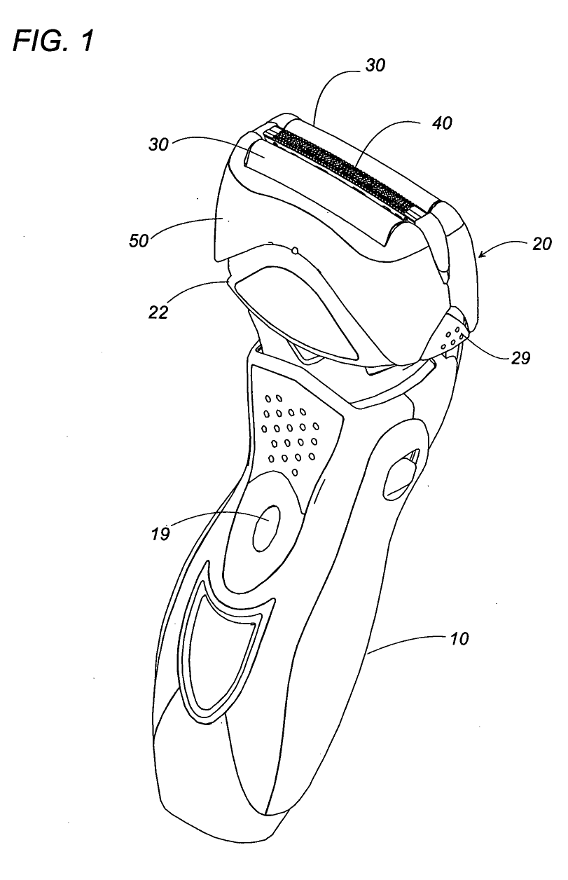

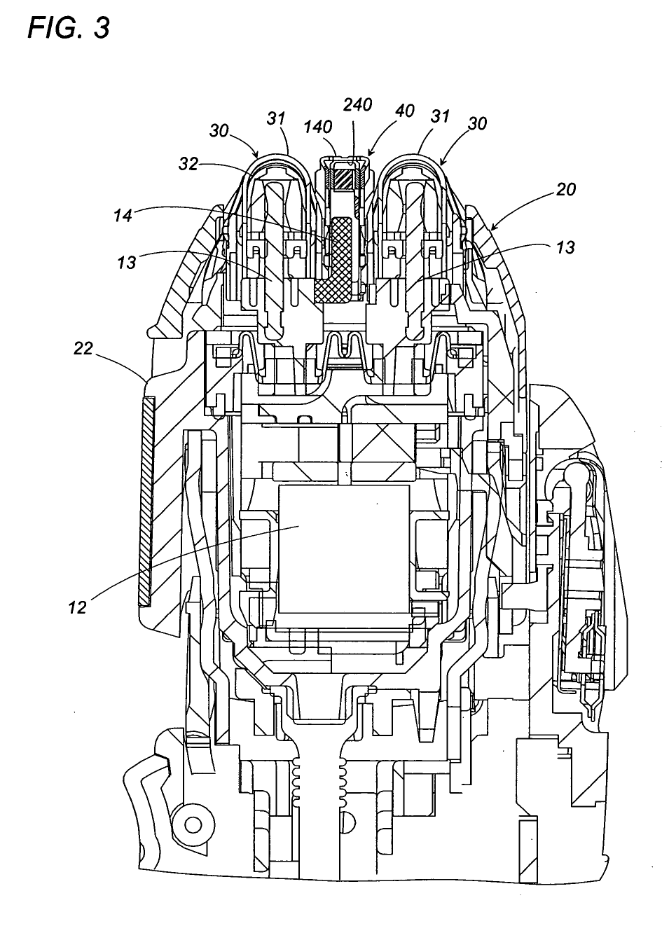

Referring now to FIGS. 1 to 3, there is shown a dry shaver equipped with a shaving head in accordance with a preferred embodiment of the present invention. The shaver is basically composed of an elongated grip 10 and the shaving head 20 mounted on top of the grip 10. The grip 10 accommodates therein a motor 12 for operating the shaving head 20.

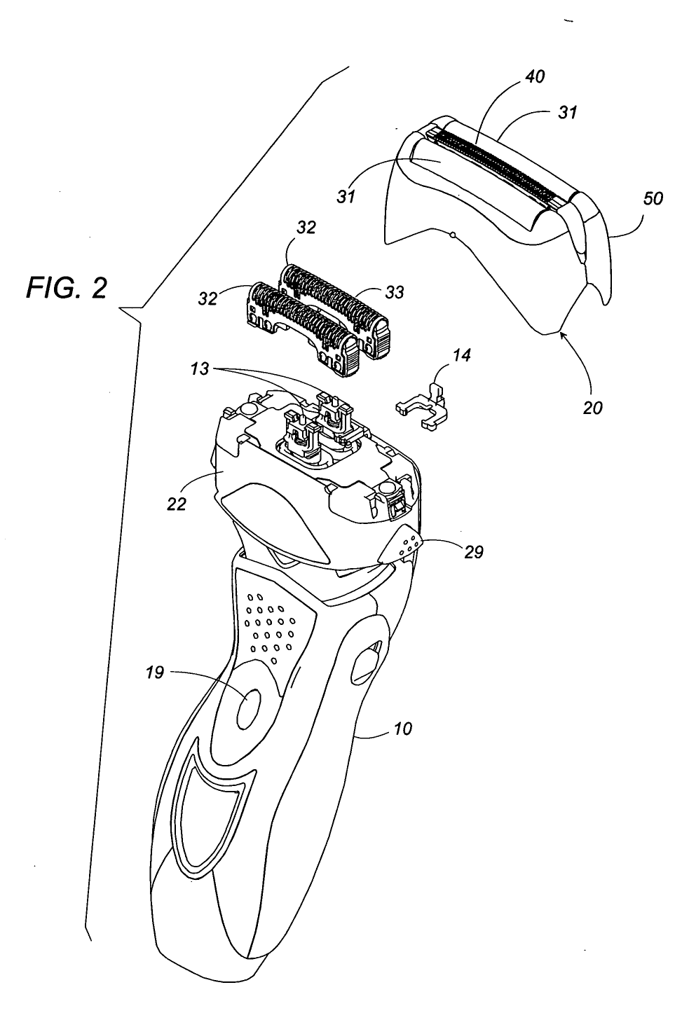

The shaving head 20 includes two perforated cutter units 30 and a slit cutter unit 40 interposed between the perforated cutter units 30. Each perforated cutter unit 30 is designed for shaving relatively short hairs, and includes an outer arcuate foil 31 with a plurality of perforations and an associated inner cutter 32 composed of a plurality of arcuate blades 33. The slit cutter unit 40 is designed for shaving relatively long hairs, and includes an elongated outer straight cutter 140 with a plurality of slits 42 and an inner cutter 240, the details of which will be explained later. Also included in the shaving head 20 is a cradle case 22 which mounts a detachable cutter holder 50 carrying the two outer arcuate foils 31 and the slit cutter unit 40, as best shown in FIG. 2. The inner cutters 32 and 240 are driven by the motor 12 to reciprocate relative to the outer arcuate foils 31 and outer straight cutter 41. Release buttons 29 are provided on opposite ends of the cradle case 22 for releasably holding the cutter holder 50. The cradle case 22 is also configured to accommodate therein the motor 12 with two output elements 13 which project on top of the cradle case 22 for connection with the inner cutters 32. A pin 15 is secured to one of the output elements 14 and is detachably connected to the inner cutter 240 of the slit cutter unit 40 for reciprocating the same. The output elements 13 and the pin 14 are collectively referred to as a driving element for reciprocating the inner cutters 32 and 240.

The cradle case 22 is formed separately from the hand grip 10 and is movably supported thereby by a support mechanism so as to be capable of effecting a combination of swiveling and depressing movements relative to the hand grip 10 in order to bring the cutter units 30 and 40 into smooth and effective shaving contact with various areas of the user's skin. The hand grip 10 accommodates therein rechargeable batteries as well as a circuit board mounting electronic components realizing a driving circuit for driving the motor and a charging circuit for the batteries. A switch button 19 is disposed in a curved recess on front of the hand grip 10 to activate the driving circuit for energizing the motor 12 to reciprocate the inner cutters.

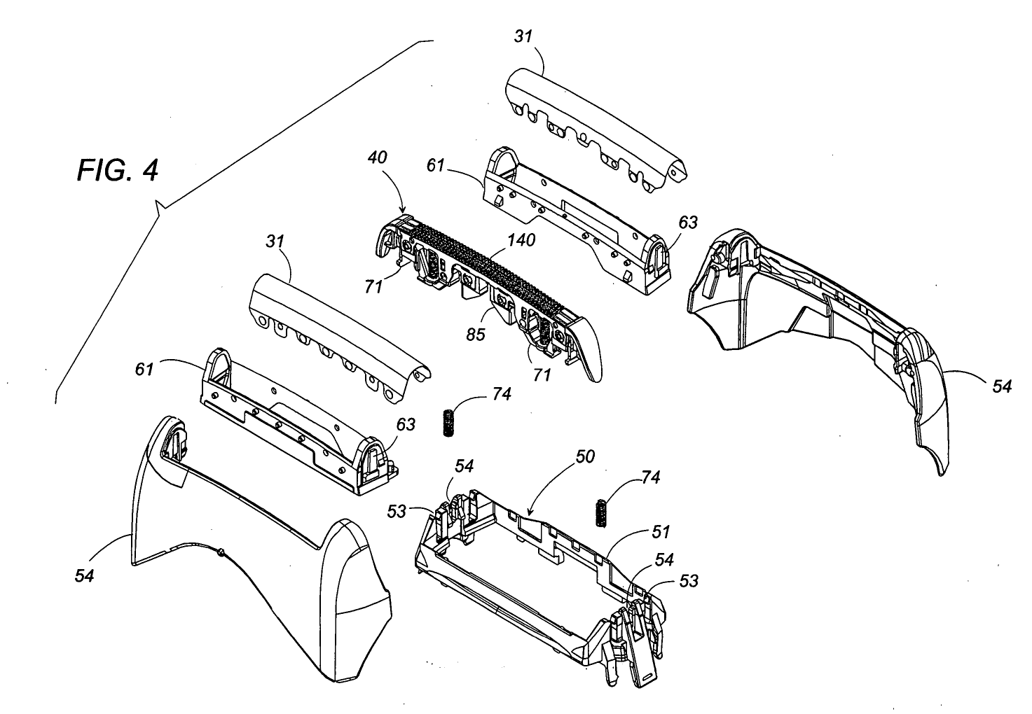

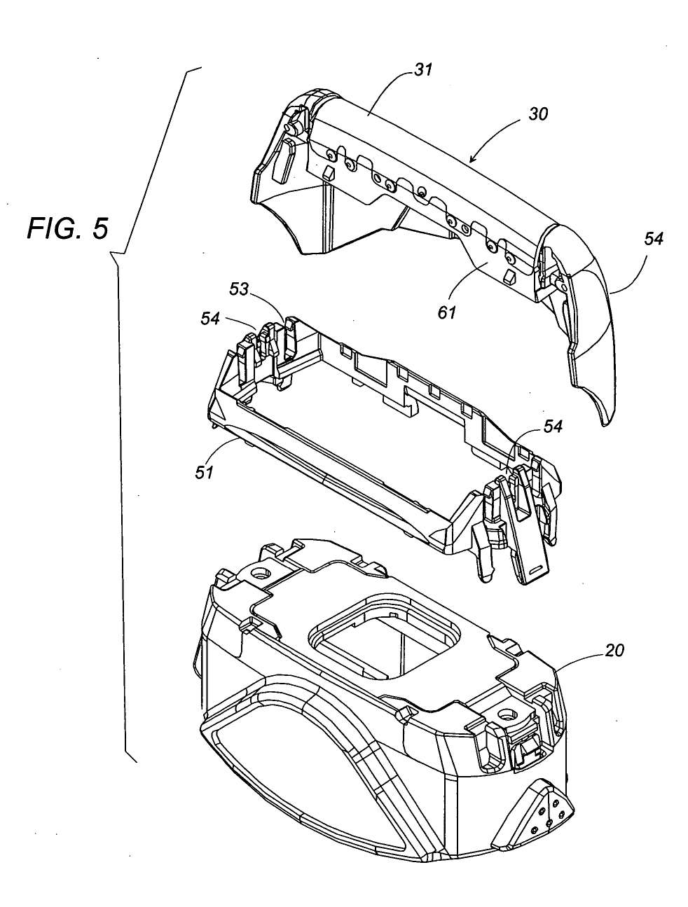

As shown in FIGS. 4 and 5, the cutter holder 50 includes a rectangular frame 51 which supports a pair of cassettes 61 each carrying the foils 31 of the perforated cutter unit 30, in addition to the slit cutter unit 40. Each cassette 61 is formed at its longitudinal ends respectively with studs 63 which are slidably received in vertical slots 53 in the longitudinal ends of the frame 51 so that the cassette 61 or the outer cutter 31 carried thereon is movable at either longitudinal ends relative to the frame 51 and is therefore capable of being depressed and even inclined with respect to the width axis of the cradle case 22. A cover 54 is fixed to each cassette 61 to be movable therewith and conceal a major portion of the cradle case 22 therebehind.

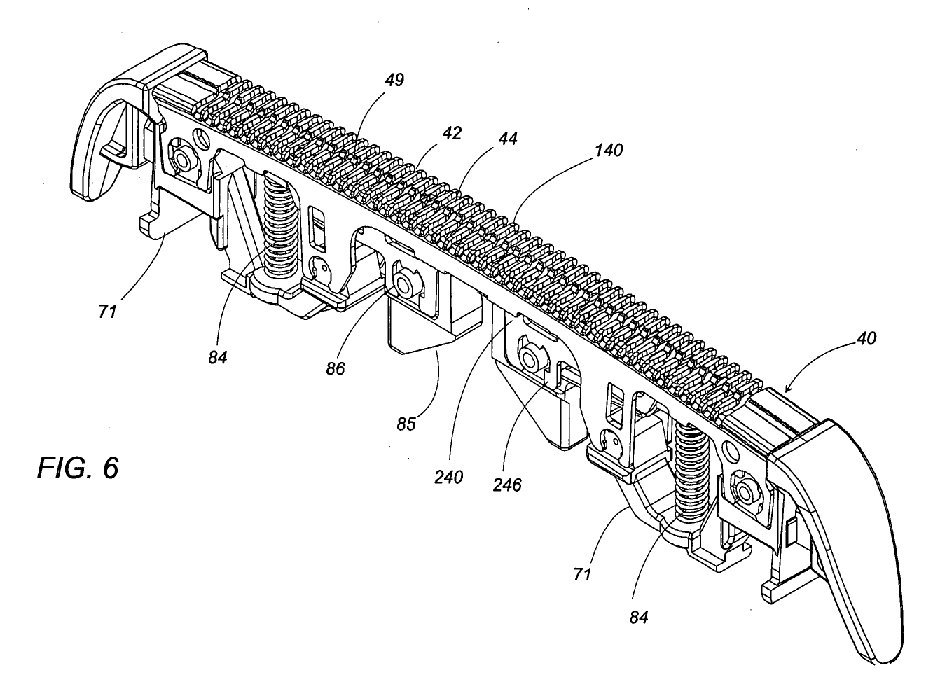

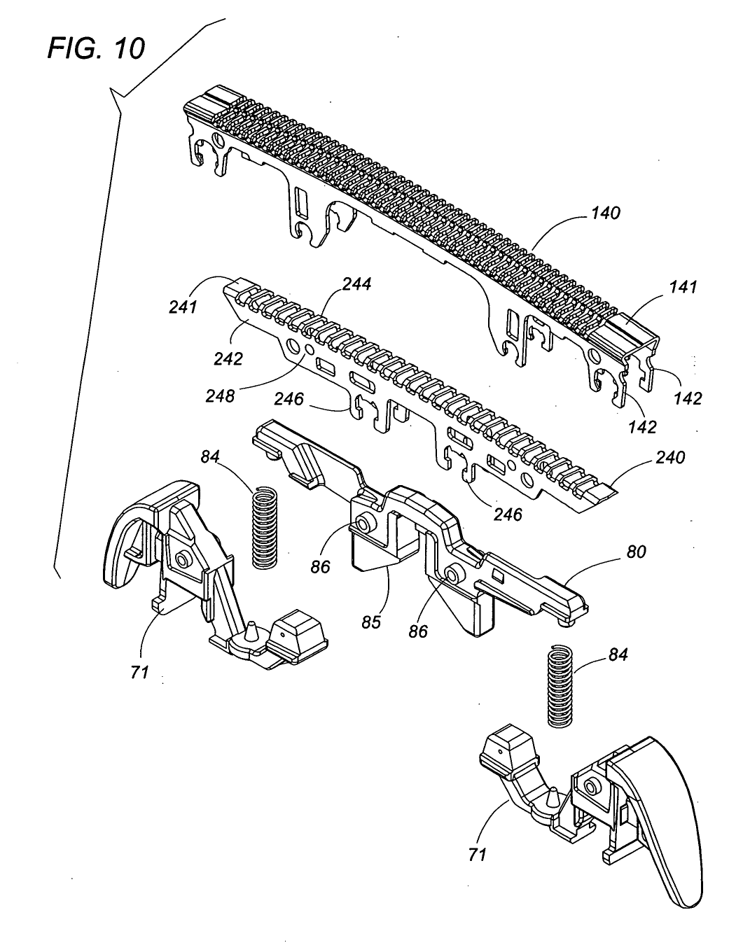

As shown in FIGS. 6 to 10, the slit cutter unit 40 includes a chassis which carries the outer cutter 140 and retains the inner cutter 240 in such a manner as to allow the reciprocating movement of the inner cutter 240 relative to the outer cutter 140. The chassis is composed of two end supports 71 which are secured to the opposite lengthwise ends of the outer cutter 41, respectively, and which support a coupler 80 carrying the inner cutter 240 by means of springs 84 such that the inner cutter 240 is movable relative to the outer cutter 140 with a suitable contact pressure therebetween. The coupler 80 is made of a plastic material and is formed at its center with a joint 85 for connection with the driving element, i.e., the pin 14 projecting on top of the cradle case 22. The coupler 80 is also formed with studs 86 which are mechanically engaged and heat-sealed to associated C-shaped hooks 246 on the side of the inner cutter 240 shaped from a metal sheet. Each of the end supports 71 is slidably received in center vertical slots 54 of the frame 51 and is secured to one of the cassettes 61 to be movable together therewith relative to the frame 51 or the cradle case 22, and is therefore allowed to be depressed or inclined with respect to a width axis of the cradle case 22. When the cutter holder 50 is attached to the cradle case 22, each outer foils 31 can be allowed to be independently depressed against a spring force acting on the inner cutter 32 by a spring provided in each of the drive elements 13 on the side of the cradle case 22. Further, the inner cutter 32 is swingably connected to the drive element 14 such that each perforated cutter unit 30 can be inclined in opposite directions, in addition to being depressed relative to the cradle case 22 in the like manner as the cradle case does relative to the hand grip.

The end supports 71 are mounted to the frame 51 and are biased upwardly therefrom by longitudinally spaced springs 74. The bias of the springs 74 is additive to the spring bias acting on the inner cutter 240 to give a strong resisting force to the combination of the slit cutter unit 40 and the outer cutter 72 of the one perforated cutter unit 30 movable together with the slit cutter unit 40. Thus, the combination is made more resistive to the depressing and inclining movements than the other perforated cutter unit 30, whereby the cutter units 30 on opposite sides of the slit cutter unit 40 can be depressed or inclined independently from each other against different resistances.

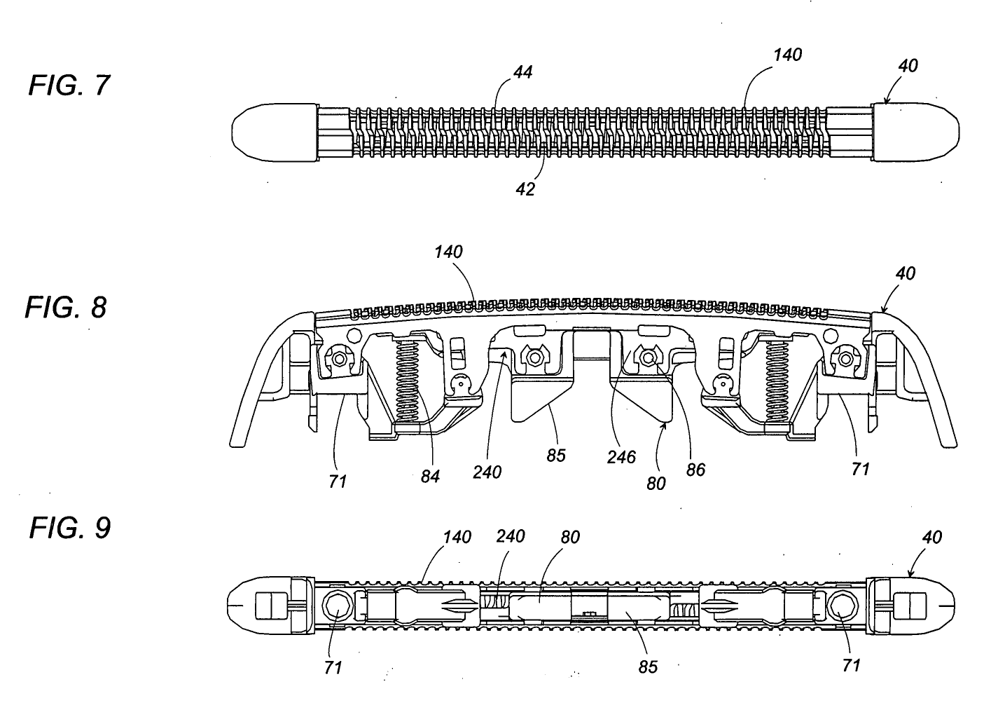

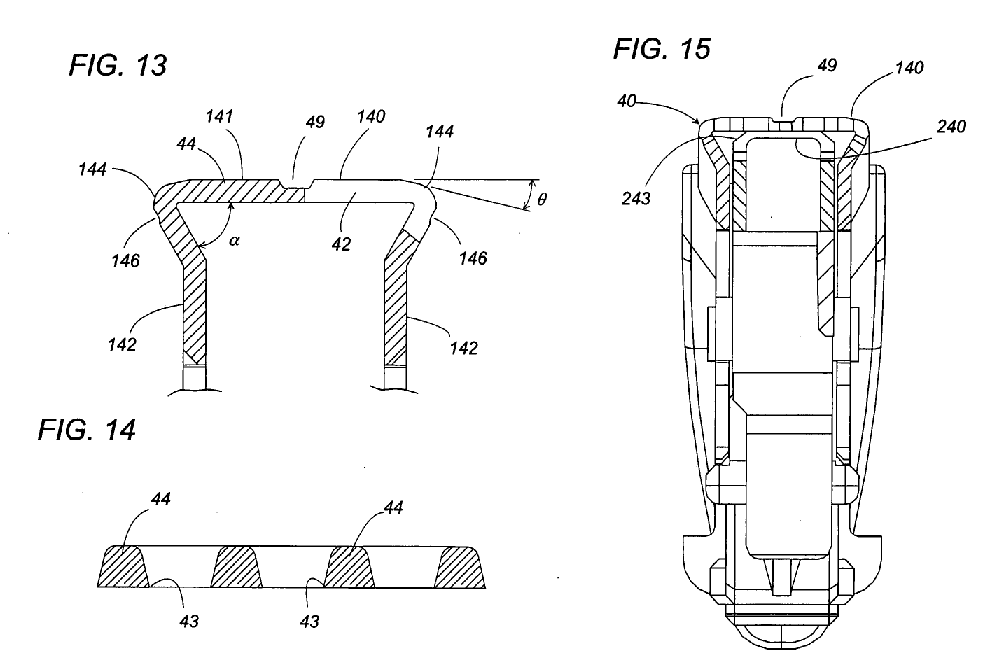

Referring to FIGS. 7 to 13, the outer cutter 140 of the slit cutter unit 40 is shaped from a single metal sheet into a generally U-shaped configuration having a crossbar 141 and a pair of legs 142 depending from opposite width ends of the crossbar 141. As best shown in FIG. 13, the upper end of each leg 142 is bent at an angle (α) of about 60° with respect to the crossbar 141 to define an angled shoulder 144 thereat. The crossbar 141 is finished to have a flat top surface and a flat bottom surface, except at the width ends where the top surface declines towards the angled shoulder 144 at an angle (β) of about 12°.

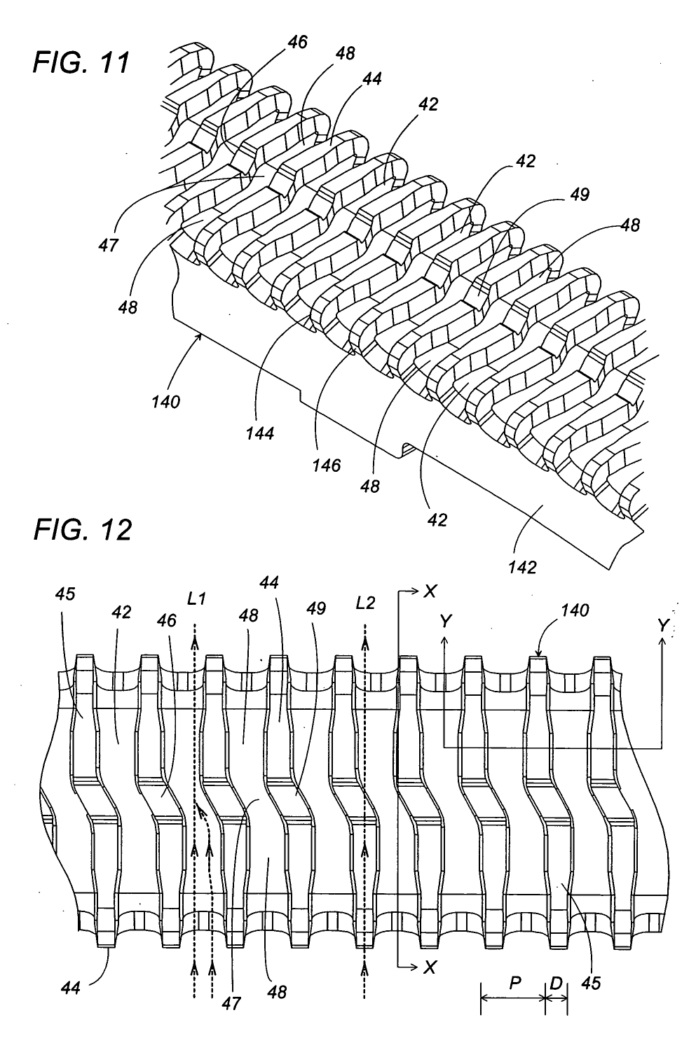

The slits 42 are arranged along a lengthwise axis of the outer cutter 140 to leave a plurality of parallel bridges 44 each between the adjacent ones of the slits. Each slit 42 extends over the full width of the crossbar 141 into the upper ends of the legs 142, i.e., the angled shoulders 144, as best shown in FIGS. 11 and 13. A dent 146 is formed immediately below the tip of the shoulder 144 which acts to raise the flattened hairs.

Each of the bridges 44 is formed at its longitudinal center with a deflection 46 which is angled with respect to the width axis of the outer cutter 140 so as to give a deflection path 47 in each slit 42 at the width center of the outer cutter 140. Thus, each slit is formed on opposite width ends of the outer cutter 140 with straight slit paths 48 which are staggered with respect to each other along the lengthwise axis of the outer cutter 140, and communicate with each other through the deflection path 47, as shown in FIG. 9. The straight slit paths 48 run generally in a direction perpendicular to the lengthwise axis of the outer cutter, and are staggered with respect to each other by a distance (D) of about ¼ to ½ of a pitch (P) at which the bridges 44 are arranged along the lengthwise axis.

The deflection 46 is bent within a horizontal plane to make the bottom surface of the whole bridge 44 smoothly continuous through the deflection, as shown in FIG. 13. With this result, the inner cutter 240 can be made into a simple structure having a plurality of flat blades 244 each capable of being kept in contact with the bottom surface of the bridges 44 over a wide area including the deflections 46, thereby enhancing cutting efficiency of the outer cutter 140. Further, since the straight slit paths 48 are continuous through the deflection path 47 as being confined between the side faces of the deflection 46, the hairs entrapped in one of the straight slit paths can be smoothly guided through the deflection path 47 to the other straight path 48 while the shaving head 20 is moving across the user's skin in the direction perpendicular to the lengthwise axis of the outer cutter, as shown in dotted lines L1, thereby being given an increased chance of being cut, by making the best use of the inner cutter 240 designed to be kept in contact with the bottom surface of the bridges including the deflections. Thus, the hair can be cut even in the deflection path 47 or immediately before or after advancing to and from the deflection path. While the shaving head 20 is moving across the skin, the hair that has been flattened as being pressed by one end of the bridge 44 is permitted to rise up into the deflection path 47 and subsequently into one of the straight slit paths 48, as indicated by dotted lines L2 in FIG. 12.

Further, the outer cutter 140 is formed in its top surface of each deflection 47 with a notch 49. The notch 49 has parallel straight edges running in the lengthwise axis on top of the bridge 44 for raising the flattened hair and guiding it into one of the straight slit paths 48 behind the notch 49 with respect to the moving direction of the shaving head for increasing the cutting efficiency in combination of the staggered slit arrangement. That is, the initially flattened hair can be raised by the edges of the notch 49 so as to be successfully cut immediately after it enters into the deflection path 47 or the straight slit paths 48.

As best shown in FIG. 12, each of the bridges 44 is shaped to have a tapered section 45 at an intermediate portion between the deflection 46 and each longitudinal end, in order to have a width smaller at the each longitudinal end than at the a portion adjacent to the deflection 46, thereby enlarging a width of the straight slit path 48 at its open end for introducing the hairs into the slit with enhanced efficiency. Further, as shown in FIG. 14, each of the bridges 44 has a trapezoidal cross section along the length wise axis with the bottom surface defining a longer base side and the top surface defining a shorter top side of the trapezoid, in order to give sharp cutting edges 43 at the opposite lower ends of the bridge for enhancing the cutting efficiency, in addition to that the hair can be readily introduced into the slits. The opposite top ends of the bridge are rounded to give a soft contact with the skin.

The inner cutter 240 is also made from a single metal sheet into a generally U-shaped configuration having a crossbar 241 and a pair of legs 242 depending from opposite width ends of the crossbar 241 through beveled edges 243. The inner cutter is cut at a portion extending from the crossbar 241 to the upper end of the legs through the beveled edges 243 to give a plurality of the flat blades 244 each having a smooth straight top surface in shearing contact with the bottom surface of the bridges 44, as shown in FIG. 15. The hooks 246 extend from the center of the individual legs 242 for secure connection with the coupler 80 through the mechanical engagement and the heat-welding with the studs 86 on both sides of the coupler 80. The inner cutter 240 is also formed on each of the legs 242 with spacer projections 248 which are kept in sliding contact with the inner surfaces of the legs of the outer cutter for an exact widthwise positioning of the inner cutter in relation to the outer cutter 140.

The perforated cutter unit 30 and the slit cutter unit 40 are each shaped to have an arcuate contour along the lengthwise axis with a longitudinal center projecting than the opposite lengthwise ends in order to make a smooth fit on curved skin surface areas, particularly a concave skin area, for example, the lower jaw.

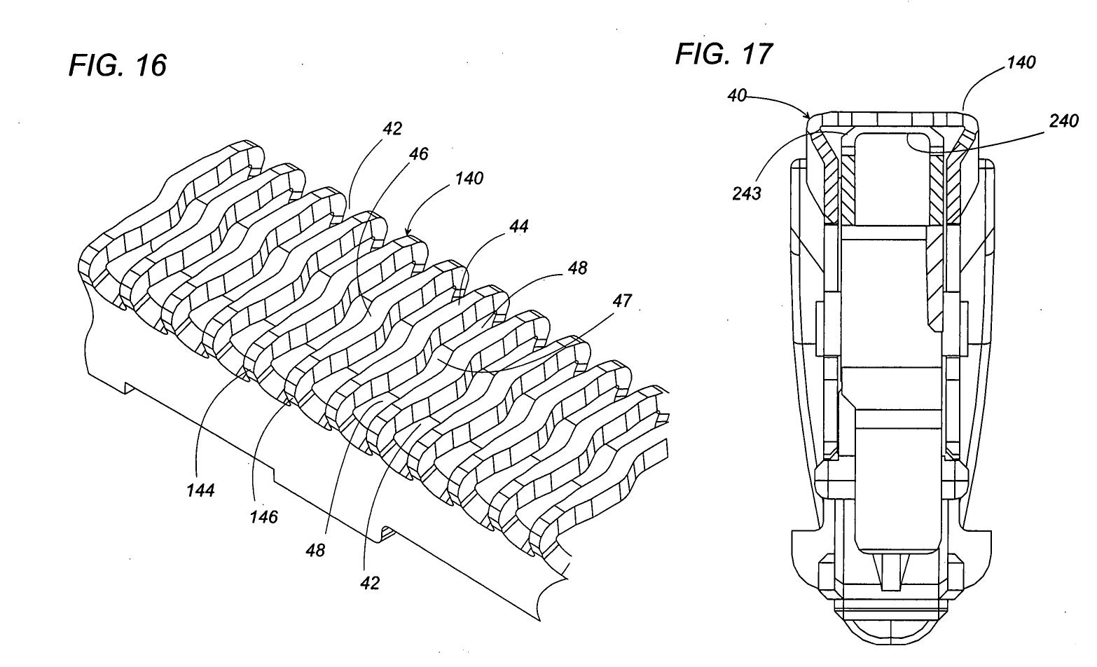

As shown in FIGS. 16 and 17, the outer cutter 140 of the slit cutter unit 40 may be shaped to be devoid of the notch in the top surface of each deflection 46. The notch may be alternately formed in the top surface of each bridge other than the deflection. Like parts are designated by like reference numerals for easy comprehension.

1. A shaving head for a dry shaver, said shaving head having a slit cutter unit which comprises:
an outer cutter shaped to have a top surface for contact with a user's skin, said outer cutter being elongated to have a lengthwise axis and a width axis;
an inner cutter driven to reciprocate along said lengthwise axis in engagement with a bottom surface of said outer cutter;
said outer cutter configured to have a U-shaped structure having a pair of legs connected by a crossbar,
said outer cutter being shaped to have a plurality of slits which are spaced in said lengthwise axis to leave a plurality of bridges each between the adjacent ones of said slits,
said slits extending continuously over a full width of said crossbar and into upper ends of said legs in a direction generally perpendicular to said lengthwise axis to give two straight slit paths respectively on opposite width ends of said outer cutter, said straight slit paths on opposite width ends being staggered with respect to each other along said lengthwise axis,
wherein
each of said bridges extends along said width axis of said outer cutter to make said bottom surface of said outer cutter smoothly continuous over the full length of said bridge,
each of said bridges is formed at its longitudinal center with a deflection which is angled with respect to said width axis so as to leave, between the adjacent ones of said deflection, an angled path through which said straight slit paths of each slit extends continuously.

2. The shaving head as set forth in claim 1, wherein said outer cutter being shaped from a single metal sheet.

3. The shaving head as set forth in claim 1, wherein each of said bridges has, along said lengthwise axis, a trapezoidal cross-section with a longer base side defined by said bottom surface and with a shorter top side defined by said top surface of said outer cutter.

4. The shaving head as set forth in claim 1, wherein each of said bridges is formed in its top surface with a notch.

5. The shaving head as set forth in claim 4, wherein said notch is formed in the top surface of said deflection.

6. The shaving head as set forth in claim 1, wherein said outer cutter has its top surface curved along said lengthwise axis to have its lengthwise center projecting than opposite lengthwise ends thereof.

7. The shaving head as set forth in claim 1, wherein each of said bridges is tapered towards its longitudinal ends thereof to have a width which is smaller at the longitudinal ends than at said deflection.

8. The shaving head as set fort in claim 1, further including a perforated cutter unit which comprises:
an outer foil having a plurality of perforations; and
an inner cutter driven to move relative to said outer cutter foil.

9. A dry shaver comprising:
the shaving head of claim 8,
a motor having a driving element which is connected to drive said inner cutters.

10. The dry shaver as set forth in claim 9, wherein
the inner cutter of said slit cutter unit is made of a metal into a unitary structure having a hook for engagement with a coupler made of a plastic material for connection with said driving element,
said coupler having studs which are mechanically engaged with and heat-welded to said hook.
